(19) United States
(12) Patent Application Publication
(10) Pub. No.: US 2026/0160587 A1
(43) Pub. Date: Jun. 11, 2026

(54) METHOD FOR DETERMINING A CORRECTION FUNCTION

(71) Applicant: Endress+Hauser Flowtec AG, Reinach (CH)

(72) Inventors: Simon Mariager, Basel (CH); Heinz Rufer, Dornach (CH); Frank Schmalzried, Zolling (DE)

(21) Appl. No.: 19/102,453

(22) PCT Filed: Jul. 17, 2023
(86) PCT No.: PCT/EP2023/069823

§ 371 Date: Feb. 10, 2025

(30) Foreign Application Priority Data
Aug. 26, 2022 (DE) 10 2022 121 702.7

(51) Int. Cl. G01F 25/10; G01F 1/60

(52) U.S. Cl. CPC G01F 25/10; G01F 1/60

(57) ABSTRACT

A method for determining a correction function of a flow-velocity-dependent measurement variable of a flowable medium for a magnetic-inductive flow meter or for a magnetoinductive flow measuring probe comprises modeling a magnetic-field-generating device by a numerical simulation method, wherein the modeling is influenced by a magnetic permeability of the magnetic-field-generating device, determining a first reference state, wherein the medium to be guided has a first magnetic permeability in the first reference state, determining a second reference state, wherein the medium to be guided has a second magnetic permeability different from the first permeability in the second reference state, determining a deviation between the first reference state and the second reference state; and deriving a correction function from the deviation. Further disclosed are a method for correcting a flow-velocity-dependent measurement variable, a magnetoinductive flow meter, and a magnetoinductive flow measuring probe.

The invention relates to a method for determining a correction function, a method for correcting a flow-velocity-dependent measurement variable, a magnetoinductive flow meter and a magnetoinductive flow measuring probe.

Magnetic-inductive flow meters are used for determining the flow rate and the volumetric flow of a flowing medium in a pipeline. A distinction is made here between in-line magnetic-inductive flow meters and magnetic-inductive flow measuring probes, which are inserted into a lateral opening of a pipeline. A magnetoinductive flow meter has a magnetic-field-generating device for generating a magnetic field. A main axis of the magnetic field runs substantially perpendicular to the flow direction of the flowing medium. Saddle or cylindrical coils are usually used for this purpose. In order to realize a predominantly homogeneous magnetic field, pole shoes are additionally formed and attached relative to the flow direction such that the magnetic field lines run over the entire pipe cross section substantially perpendicularly to the transverse axis or in parallel to the vertical axis of the measuring tube. In addition, a magnetoinductive flow meter has a measuring tube on the lateral surface of which the magnetic-field-generating device is arranged. A measurement electrode pair attached to the lateral surface of the measuring pipe taps an electrical measurement voltage or potential difference which is applied perpendicularly to the direction of flow and to the magnetic field and occurs when a conductive medium flows in the direction of flow when the magnetic field is applied. Since, according to Faraday's law of induction, the tapped measurement voltage depends on the velocity of the flowing medium, the flow rate and, with the inclusion of a known pipe cross-section, the volumetric flow can be determined from the induced measurement voltage.

In contrast to a magnetic-inductive flow meter, which comprises a measuring tube for conducting the medium with an attached device for generating a magnetic field penetrating the measuring tube and with measuring electrodes, magnetic-inductive flow measuring probes are inserted with their usually circular cylindrical housings into a lateral opening of a tube line and fixed in a fluid-tight manner. A special measuring tube is no longer necessary. The measuring electrode arrangement and coil arrangement, mentioned in the introduction, on the lateral surface of the measuring tube are omitted and are replaced by a device for producing a magnetic field, which device is arranged in the interior of the housing and in direct proximity to the measuring electrodes and is designed such that an axis of symmetry of the magnetic field lines of the produced magnetic field perpendicularly intersects the front face or the face between the measuring electrodes. In the prior art, there is already a plurality of different magnetic-inductive flow measuring probes.

Magnetic-inductive flow meters are often used in process and automation engineering for fluids, starting from an electrical conductivity of approximately 5 μS/cm. Corresponding flow measurement devices are sold by the applicant in a wide variety of embodiments for various fields of application, for example under the name PROMAG or MAGPHANT.

It is known that magnetic solids in the medium can lead to an increased error in the determination of the flow-velocity-dependent measurement variable. One reason for this is that the magnetic flux density of the magnetic field generated during measuring mode is usually not measured. Instead, a preset and expected magnetic flux density is assumed to determine the flow-velocity-dependent measurement variable. However, this is determined at the factory under ideal conditions and does not correspond to the actually present magnetic flux density if magnetic solids are present in the flowing medium.

DE 10 2006 026 772 A1 discloses a method for determining a flow-velocity-dependent measurement variable by means of a magnetoinductive flow meter, in which conclusions are drawn about the presence of magnetically conductive solids in the medium based on a deviation of the current rise time—which must be waited until a magnitude of the magnetic field (i.e. the magnetic flux density) assumes a predefined target value—from a predefined rise time. Based on the deviation, a correction factor is then determined with which the measurement error is compensated.

The object of the invention is to provide an alternative solution.

The object is achieved by the method for determining a correction function according to claim 1, the method for correcting according to claim 18, the magnetoinductive flow meter according to claim 21 and the magnetoinductive flow measuring probe according to claim 22.

The method according to the invention for determining a correction function of a flow-velocity-dependent measurement variable of a flowable medium for a magnetoinductive flow meter or for a magnetoinductive flow measuring probe comprises the method steps:
modeling a magnetic-field-generating device, in particular by means of a, preferably numerical, simulation method,
   wherein the modeling of the magnetic-field-generating device is influenced by a magnetic permeability of the magnetic-field-generating device or at least one individual component of the magnetic-field-generating device,
determining a first reference state,
   wherein in the first reference state, the medium to be guided has a first magnetic permeability,
determining a second reference state,
   wherein in the second reference state, the medium to be guided has a second magnetic permeability which is different from the first permeability,
determining a deviation between the first reference state and the second reference state; and
deriving a correction function from the deviation.

The method according to the invention has the advantage that it not only takes into account the magnetic properties of the magnetic-field-generating device or the individual components of the magnetic-field-generating device when determining the correction function, but also the influence of the magnetic solids on the individual components and the interaction with the individual components of the magnetic-field-generating device. Thus, the correction function of the method according to the invention is suitable for all magnetoinductive flow meters and magnetoinductive flow measuring probes with known magnetic-field-generating devices, regardless of the operating signal and control method.

Modeling within the meaning of the present application includes the creation of a model. The model is preferably created using a simulation process. Alternatively, modeling may also include creating a prototype. In this case, a test setup with adjustable conditions corresponding to the first reference state and the second reference state is created and measured.

It is particularly advantageous to create the model using a suitable simulation method. A numerical simulation method such as the finite element method is particularly suitable for this purpose.

The creation of correction functions or correction factors using simulation methods in general is already known. From U.S. Pat. No. 11,199,436 B2, a magnetoinductive flow meter is known in which certain correction factors are stored, using the finite element method and computational flow dynamics (CFD), to correct measurement errors that are caused by disturbances at the inlet and/or outlet side (bend, valve, etc.). Said disturbances result in an asymmetric flow profile, and the assumption usually made when configuring the magnetoinductive flow meter, that a completely rotationally symmetrical flow profile is present, no longer holds. However, the present invention is to be distinguished from the cited prior art, since the present solution does not take into account the influences of the process line on the flow profile in the measuring tube, but rather the influence of magnetic solids on the magnetic-field-generating device and the magnetic field generated thereby.

The first reference state can, for example, reflect the state of the magnetoinductive flow meter or the magnetoinductive flow measuring probe during adjustment. In this case, the medium can consist of water which is free of magnetic solids.

In the second reference state, the medium can contain magnetic solids. For the sake of simplicity, a second magnetic permeability is assigned to the medium as a whole. However, especially in the simulation, it is also possible to provide a multiphase medium in which the individual phases have different magnetic permeabilities.

The flow-velocity-dependent measurement variable includes the electrical potential applied to a measuring electrode, the measurement voltage between two measuring electrodes, the determined flow velocity, the determined volumetric flow and/or the determined mass flow.

Advantageous embodiments of the invention are the subject matter of the dependent claims.

One embodiment provides that the modeling of the magnetic-field-generating device comprises adapting it so that a magnetic characteristic of the magnetic-field-generating device resulting from the modeled magnetic-field-generating device, in particular a self-inductance of the magnetic-field-generating device, lies within a characteristic tolerance range, in particular a self-inductance tolerance range, which is in particular determined experimentally.

The advantage of this design is that the magnetic characteristics of the device generating the magnetic field are included in the model and thus enable a more accurate correction. The magnetic characteristic, in particular the self-inductance, can be determined using the magnetoinductive flow meter or the magnetoinductive flow measuring probe. The determination of self-inductance is taught, for example, in WO 2021/121960 A9 and WO 2021/110442 A1, to which reference is made in full. For example, the self-inductance present during operation results from the coil current curve, and/or voltage curve, over time. In the simulation, for example the simulated self-inductance L results from the volume integral over the product of the magnetic field strength H and the magnetic flux density B divided by the square of the coil current I². The self-inductance L depends directly on the magnetic permeability of the medium, but not on the flow-velocity-dependent variable of the medium.

The self-inductance tolerance range can consist of a single self-inductance value that is determined for a single measuring device, or can consist of a range that is spanned by a multiplicity of measured self-inductance values of different measuring devices.

One embodiment provides that the modeling of the magnetic-field-generating device comprises adapting it so that a calibration factor C resulting from the modeled magnetic-field-generating device lies within a calibration factor tolerance range, in particular one that is determined experimentally.

For an optimal design of the model, it is advantageous to check whether the calibration factor C resulting from the model lies within an experimentally determined calibration factor tolerance range. The experimentally determined calibration factor tolerance range results, for example, from the set of calibration factors for already manufactured and adjusted magnetoinductive flow meters or magnetoinductive flow measuring probes. The calibration factor C resulting from the model can be determined, for example, by calculating the electrical potentials in the measuring cross section at a set flow velocity.

The calibration factor tolerance range can consist of a single calibration value that is intended for a single measuring device, or of a range that is spanned by a multiplicity of measured calibration values from different measuring devices.

One embodiment provides that the modeling of the magnetic-field-generating device comprises an adaptation thereof so that a linearity resulting from the modeled magnetic-field-generating device lies within a linearity tolerance range, in particular one that is determined experimentally.

Linearity is a measure of how independent of the Reynolds number the induced measurement voltage is over the largest possible Reynolds number range (usually 10⁴ up to 10⁶). If a magnetoinductive flow meter or a magnetoinductive flow probe is linear over a given Reynolds number range and is thus independent of the Reynolds number, the correction factor C can be chosen to be constant, and the simplification U=f·S·u can be assumed, where U is the induced measurement voltage, f is a Reynolds-dependent function—which in this case is, however, constant—, S is the nominal signal strength and u is the flow rate. The linearity of the model can be calculated for the adjustment. The calculated linearity is then compared with a linearity tolerance range.

The linearity tolerance range can consist of a single linearity value that is determined for a single measuring device or of a range that is spanned by a multiplicity of measured linearity values from different measuring devices.

One embodiment provides that when modeling the magnetic-field-generating device, a distance is assumed between at least two individual components of the magnetic-field-generating device, or between a measuring tube of the magnetoinductive flow meter and the magnetic-field-generating device, or between a housing wall of the magnetoinductive flow measuring probe and the magnetic-field-generating device,
wherein the modeling comprises adjusting the distance until the variables to be adjusted match the corresponding tolerance range.

The advantage of the embodiment is that a more precise match can thereby be achieved between the simulated magnetoinductive flow meter or the simulated magnetoinductive flow measuring probe, in particular the magnetic characteristics resulting from the simulations and the magnetic characteristic of a real magnetoinductive flow meter or a magnetoinductive flow measuring probe. By assuming a distance between two individual components of the magnetic-field-generating device, e.g. in the form of an air gap, influences from boundary regions between the usually ferromagnetic individual components can be taken into account in the modeling.

One embodiment provides that the magnetic-field-generating device comprises a coil and a coil core,
wherein the magnetic permeability of the coil core is taken into account in the modeling of the magnetic-field-generating device.

One embodiment provides that the magnetic-field-generating device comprises a pole shoe,
wherein the magnetic permeability of the pole shoe is taken into account in the modeling of the magnetic-field-generating device.

One embodiment provides that the magnetic-field-generating device comprises two, in particular diametrically arranged, coils, each with a coil core and a field guide body connecting the two coil cores,
wherein the magnetic permeability of the two coil cores and of the field guide body is taken into account in the modeling of the magnetic-field-generating device.

One embodiment provides that the magnetic-field-generating device comprises a coil, in particular not having a coil core, and a field guide body,
wherein the magnetic permeability of the field guide body is taken into account in the modeling of the magnetic-field-generating device.

One embodiment provides that in the first reference state, a first magnetic characteristic, in particular a first self-inductance or a variable dependent thereon, is determined,
wherein in the second reference state, a second magnetic characteristic deviating from the first magnetic characteristic, in particular a second self-inductance deviating from the first self-inductance or a variable deviating therefrom, is determined.

The self-inductance of the magnetic-field-generating device determined during operation includes not only the inductance resulting from the coil arrangement, but also its temperature dependence and its dependence on external magnetic fields. If the medium to be conveyed contains ferromagnetic solids, these influence the generated magnetic field, in particular the magnetic flux in the medium. As a first approximation, the medium and the ferromagnetic solid can be interpreted as part of the coil core of the coil. An approximate formula for the self-inductance of a long coil is L=μ₀μᵣN²A·l⁻¹, where A is the cross-sectional area of the coil, N is the number of turns, and l is the length of the coil. In a first approximation, ferromagnetic solids thus influence the μᵣ, which can no longer be assumed to be constant. Thus, self-inductance is not only a variable that can change, but also a variable that is extremely sensitive to external magnetic fields, e.g. generated by magnetic foreign bodies.

The determination of the self-inductance for the first reference state and the second reference state is advantageous because it enables a comparison with the real self-inductance of the magnetoinductive flow meter or the magnetoinductive flow measuring probe during operation.

One embodiment provides that determining a deviation between the first reference state and the second reference state comprises determining a first deviation between the first magnetic characteristic and the second magnetic characteristic, in particular the first self-inductance and the second self-inductance.

One embodiment provides that determining a deviation between the first reference state and the second reference state comprises determining a second deviation between a first flow-velocity-dependent measurement variable resulting from the first reference state and a second flow-velocity-dependent measurement variable resulting from the second reference state.

One embodiment provides that the correction function results from a functional relationship between the first deviation, or a variable derivable from the first deviation, and the second deviation, or a variable derivable from the second deviation.

The correction function can be stored in the magnetoinductive flow meter or in the magnetoinductive flow measuring probe and can be used in operation by a measuring circuit to determine a more accurate flow-velocity-dependent measurement variable.

One embodiment provides that the correction function can be described by means of a polynomial function with at least one linear part,
wherein the linear part comprises a factor A.

One embodiment provides that the factor A is a magnetic-system-geometry-specific variable.

The factor A may vary with different magnetic system geometries. This means that the factor A in a magnetic-field-generating device consisting of two diametrically arranged saddle coils deviates from a factor A which occurs in a magnetic-field-generating device consisting of two diametrically arranged cylindrical coils. However, not only the individual components generating magnetic fields, but also the individual components conducting magnetic fields, influence the factor A. Furthermore, magnetoinductive flow meters with more than two coils are known. These are usually arranged distributed in the measuring cross section. This also influences the factor A.

One embodiment provides that the factor A is selected from a first factor range with the limits 1 and 4, in particular 1.5 and 2.5, or their corresponding reciprocals, in the case in which the magnetic-field-generating device comprises a saddle coil,
wherein the factor A is selected from a first factor range with the limits 4 and 8, in particular 5 and 7, or their corresponding reciprocals in the case in which the magnetic-field-generating device comprises a cylindrical coil.

One embodiment provides that the factor A correlates with a measuring-tube-specific variable or a pipeline-specific variable, in particular with a measuring tube inner diameter or pipeline inner diameter, via a second-order polynomial function.

Surprisingly, it has turned out that the factor A correlates with the measuring tube inner diameter or pipeline inner diameter when the magnet system geometry remains the same. Thus, magnetoinductive flow meters with different nominal widths have different factors A, but these correlate with each other via a functional relationship. As the diameter increases, the factor A decreases. The correlation can be described by a second-order polynomial function.

For magnetoinductive flow measuring probes, the factor A correlates with the pipeline diameter of the process line in which the magnetoinductive flow measuring probe is arranged. For this purpose, it can be advantageous if the polynomial function for describing the correlation is stored in the magnetoinductive flow measuring probe, and the pipeline diameter of the process line can be specified by the user. The measuring circuit is set up to determine the factor A to be applied taking into account the specified pipeline diameter, and to calculate the flow-velocity-dependent measurement variable depending on the factor A.

The method according to the invention for correcting a flow-velocity-dependent measurement variable of a magnetoinductive flow meter or a magnetoinductive flow meter probe comprises the method steps:
determining a current magnetic characteristic, in particular a current self-inductance or a current variable dependent on the self-inductance, of the magnetoinductive flow meter or the magnetoinductive flow measuring probe;
determining a flow-velocity-dependent measurement variable;
applying a correction function, in particular a correction function determined by means of a method of at least one of the preceding claims, for the determined current magnetic characteristic, in particular current self-inductance or the variable dependent on the current self-inductance, for the correction of the flow-velocity-dependent measurement variable,
   wherein the correction function assigns the current magnetic characteristic, in particular the current self-inductance or the variable dependent on the current self-inductance, to a correction factor for the flow-velocity-dependent measurement variable.

One embodiment provides that the correction function is independent of the flow velocity.

One embodiment comprises the method step of:
determining an effective magnetic permeability of the medium as a function of the current magnetic characteristic, in particular of the current self-inductance, or of a variable dependent on the current self-inductance and/or of the correction factor.

The magnetoinductive flow meter according to the invention for determining a flow-rate-dependent measurement variable of a flowable medium comprises:
a measuring tube for conducting the medium;
a magnetic-field-generating device for generating a magnetic field that penetrates the measuring tube;
at least one measuring electrode for determining a measurement voltage induced in the flowable medium; and
a measuring circuit for determining the flow-velocity-dependent measurement variable; and is characterized in that the measuring circuit is set up to carry out the correction method according to the invention.

The magneto-inductive flow measurement probe according to the invention for determining a flow-rate-dependent measured variable of a flowable medium,
wherein the magnetoinductive flow measuring probe can be arranged in an opening of a pipeline, comprises:
a housing in contact with the medium,
a magnetic-field-generating device for generating a magnetic field penetrating the housing,
   wherein the magnetic-field-generating device is arranged in the housing;
at least one measuring electrode for determining a measurement voltage induced in the medium; and
a measuring circuit for determining the flow-velocity-dependent measurement variable;
   and is characterized in that the measuring circuit is set up to carry out the correction method according to the invention.

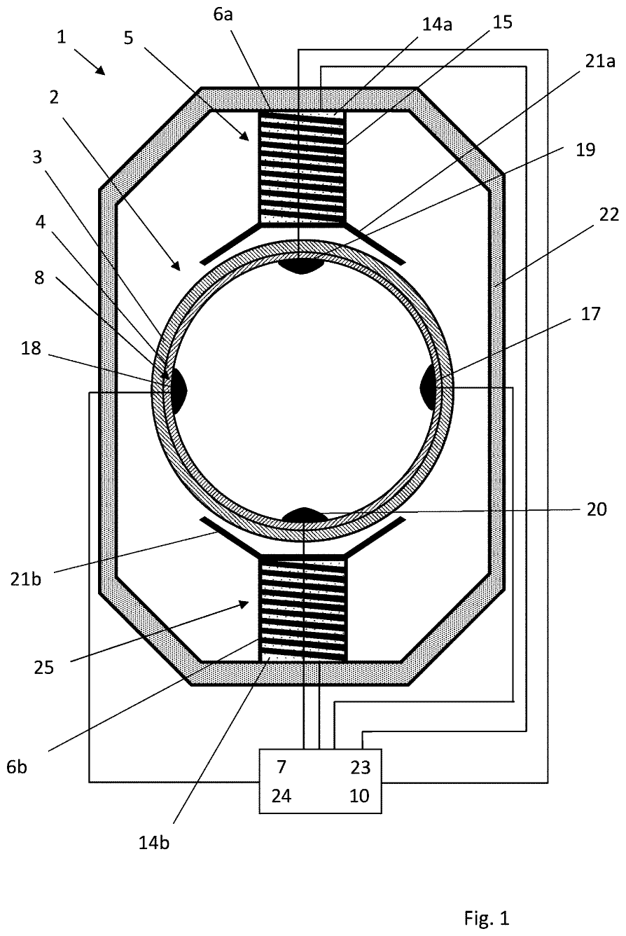

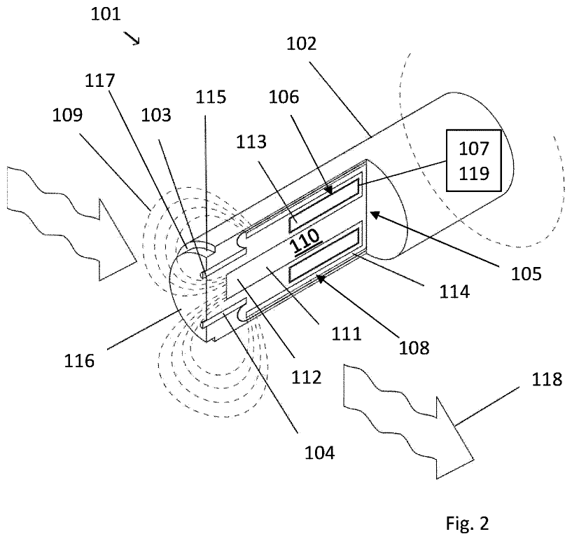

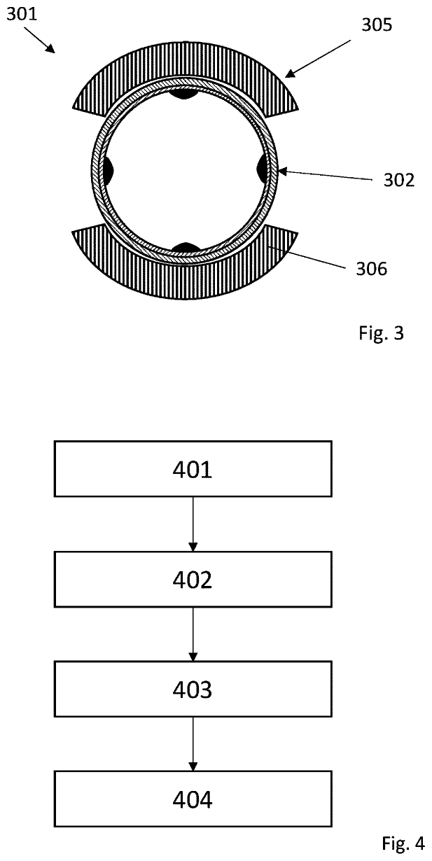

The invention is explained in greater detail with reference to the following figures. In the drawings:
FIG. 1: shows an embodiment of a magnetoinductive flow meter according to the invention;
FIG. 2: shows a perspective view of a partially cut-away embodiment of a magnetoinductive flow measuring probe according to the invention;
FIG. 3: shows another embodiment of the magneto-inductive flow meter according to the invention;
FIG. 4: shows an embodiment of the method according to the invention for correcting the flow-velocity-dependent measurement variable;

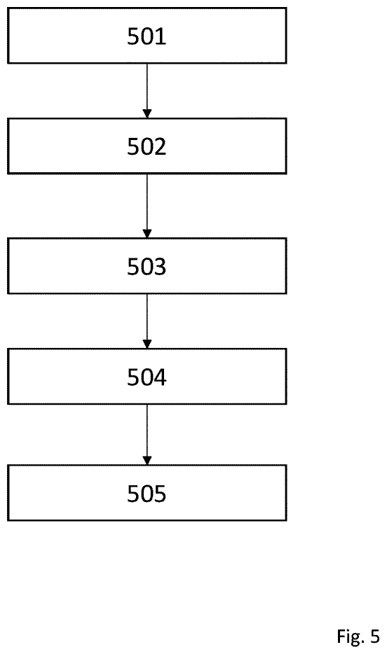

FIG. 5: shows an embodiment of the method according to the invention for determining the correction function;

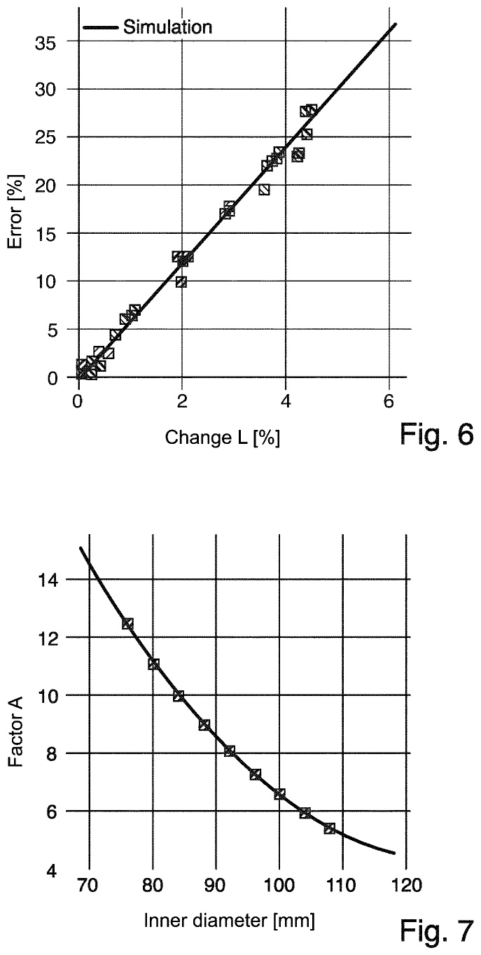

FIG. 6: shows the functional relationship between the measurement errors caused by magnetic solids in the medium and the change in the determined magnetic characteristic of the magnetic-field-generating device; and

FIG. 7: shows the functional relationship between the factor A and the measuring tube inner diameter or pipeline inner diameter.

FIG. 1 shows a cross section of an embodiment of the magnetoinductive flow meter 1 according to the invention, in particular of the measurement sensor. The structure and measuring principle of a magnetic-inductive flow meter 1 are known in principle. A flowable medium is conducted through a measuring tube 2 which must have a minimum electrical conductivity so that the flow-velocity-dependent measurement variable can be determined. The measuring tube 2 comprises a carrier tube 3, which is usually formed of, or at least comprises, steel, ceramic, plastic or glass. A magnetic-field-generating device 5 for generating a magnetic field is arranged on the carrier tube 3 such that the magnetic field lines are oriented substantially perpendicularly to a longitudinal direction defined by a measuring tube axis. The magnetic-field-generating device 5 typically comprises at least one saddle coil or at least one (cylindrical) coil 6i. A coil core 14i usually extends through a receptacle 15 of the coil 6i. The receptacle 15 is to be understood as the volume which is limited by the coil wire forming the coil 6i. The receptacle 15 of the coil 6i can thus be formed by a coil holder or by the imaginary enclosed volume. The latter occurs when the coil wire of the coil 6i is wound directly around the coil core 14i. The coil core 14i is formed from a magnetically conductive, in particular soft magnetic material. The magnetic-field-generating device 5 further comprises at least one pole shoe 21i which is arranged at one end of the coil core 14i. The pole shoe 21i can be a separate component or can be monolithically connected to the coil core 14i. In the embodiment shown in FIG. 1, two diametrically arranged coils 6a, 6b each have a coil core 14a, 14b and a pole shoe 21a, 21b. The coils 6a, 6b can be electrically connected in series. The two coil cores 14a, 14b are connected to one another via a field guide body 22. The field guide body 22 connects the sides of the coil cores 14a, 14b opposite each other and is set up to guide the generated magnetic field. However, magneto-inductive flow meters with exactly one coil 6 having exactly one coil core 14 and without a field guide body 22 are also known. The coils 6a, 6b are connected to an operating circuit 7 which drives the coils 6a, 6b with an operating signal. The operating signal can be a voltage with a time-variable curve and is characterized by operating signal parameters, wherein at least one of the operating signal parameters is controllable. The magnetic field generated by the device 5 for producing the magnetic field is produced using a pulsed direct current of alternating polarity provided by an operating circuit 7. This ensures a stable zero point and makes the measurement insensitive to influences due to electrochemical disturbances. The two coils 6a, 6b can be connected separately to the operating circuit 7 or connected in series or in parallel to one another.

When the magnetic field is applied, a flow-dependent potential distribution arises in the measuring tube 2 or in the flowing medium, which potential distribution can be detected for example in the form of an induced measurement voltage. A device 8 for tapping off the induced measurement voltage is arranged on the measuring tube 2. In the embodiment shown, the device 8 for tapping off the induced measurement voltage is formed by two oppositely arranged measurement electrodes 17, 18 to form a galvanic contact with the medium. However, magnetoinductive flow meters are also known which comprise measurement electrodes arranged on the outer wall of the carrier tube 3 that are not in contact with a medium. The measurement electrodes 17, 18 are generally arranged diametrically and form an electrode axis, or are intersected by a transverse axis which runs perpendicularly to the magnetic field lines and the longitudinal axis of the measuring tube 2. However, devices 8 are also known for tapping off the induced measurement voltage, which devices have more than two measurement electrodes. The flow-rate-dependent measurement variable can be determined on the basis of the measured measurement voltage. The flow-rate-dependent measurement variable comprises the flow rate, the volumetric flow, and/or the mass flow of the medium. A measuring circuit 23 is set up to detect the induced measurement voltage applied to the measuring electrodes 17, 18, and an evaluation circuit 24 is set up to determine the flow-velocity-dependent measurement variable and is further set up to carry out the method according to the invention for correcting the flow-velocity-dependent measurement variable.

For this purpose, the evaluation circuit 24 is designed to determine a current magnetic characteristic, in particular a self-inductance or a current variable dependent on the self-inductance. Furthermore, the evaluation circuit 24 is designed to apply a correction factor of a correction function, which is stored or determined as a function of the magnetic characteristic variable, in particular the self-inductance or the variable dependent on the self-inductance, and which is determined using the method according to the invention for determining a correction function, to the determined flow-velocity-dependent measurement variable in order to correct this variable.

The evaluation circuit 24 can be arranged in the measuring sensor or in the measuring transmitter.

The carrier tube 3 is often formed from an electrically conductive material such as steel. In order to prevent the measurement voltage applied to the first and second measurement electrodes 2, 3 from being conducted away via the carrier tube 3, the inner wall is lined with an insulating material, for example a (plastic) liner 4.

Commercially available magnetic-inductive flow meters have two further electrodes 19, 20 in addition to measurement electrodes 17, 18. In the first case, a fill-level monitoring electrode 19 optimally attached at the highest point in the measuring tube 2 serves to detect partial filling of the measuring tube 1 and is set up to pass this information to the user and/or to take into account the fill level when determining the volumetric flow. Additionally, a reference electrode 20, which is usually attached diametrically to the fill-level monitoring electrode 19 or at the lowest point of the measuring tube cross section, serves to establish a controlled electric potential in the medium. Generally, the reference electrode 20 is used to connect the flowing medium to a ground potential.

The operating circuit 7, controller circuit 10, measuring circuit 23 and evaluation circuit 24 can be part of a single electronic circuit or can form individual circuits. The evaluation circuit 24 comprises electronic components for carrying out the method according to the invention. For this purpose, it can have a microcontroller, logical electronic components and/or electrical components.

However, magnetoinductive flow meters are also known with a magnetic-field-generating device 5 differing from the one shown in the illustration. For example, the magnetic-field-generating device 5 can comprise only exactly one coil, in the form of a cylindrical coil or a saddle coil, or can also have more than two coils that are distributed over the lateral surface in the circumferential direction or also in the longitudinal direction. For an optimal design of the coil, coil cores are usually provided which extend through a coil holder. For a more homogeneous magnetic field distribution in the measuring tube, especially when using cylindrical coils, pole shoes are provided which are usually arranged between the coil and the lateral surface of the measuring tube and cover a larger surface area of the lateral surface than the coil. The pole shoe 21 does not necessarily have to have beveled areas as shown in FIG. 1, but can also be rounded and take the shape of a circular arc, as disclosed for example in WO 2021/043586 A1. The field return 22 also does not have to be angular as shown, but can also take the form of a circular arc. The field guide body 22 magnetically connects the two coil cores 6a, 6b to each other in order to achieve a more effective and faster reversal of polarity of the magnetic fields.

First, the measuring principle on which the invention is based is explained on the basis of the perspective and partially sectional illustration of FIG. 2. A flow measuring probe 101 comprises a generally circular cylindrical housing 102 having a predefined outer diameter. Said housing is adapted to the diameter of a bore which is located in a wall of a pipeline (not shown in FIG. 1) and into which the flow measuring probe 101 is inserted in a fluid-tight manner. A medium to be measured flows in the tube line, and the flow measuring probe 101 is immersed into said medium practically perpendicularly to the flow direction of the medium, which is indicated by the wavy arrows 118. A front end 116 of the housing 102 that projects into the medium is sealed in a fluid-tight manner with a front body 115 made of insulating material. By means of a magnetic-field-generating device 105 arranged in the housing 102 and comprising a coil arrangement 106, a magnetic field 109 extending through the end portion into the medium can be produced. A coil core 111, which at least partially consists of a soft magnetic material and is arranged in the housing 102, terminates at or near the end portion 116. A field return body 114 that surrounds the coil arrangement 106 and the coil core 111 is configured to return, into the housing 102, the magnetic field 109 extending through from the end portion. The coil core 111, the pole shoe 112 and the field return body 114 are each field-conducting bodies 110, which together form a field-conducting arrangement 105. A first and a second measurement electrodes 103, 104 forming a galvanic contact with the medium to be conducted form the device for detecting a measurement voltage induced in the medium and are arranged in the front body 115 and, like the outer walls of the housing, touch the medium. An electrical voltage induced due to Faraday's law of induction can be tapped at the measuring electrodes 103, 104 by means of a measuring circuit. It is at a maximum if the flow measuring probe 101 is installed in the tube line such that a plane spanned by a straight line intersecting the two measurement electrodes 103, 104 and by a longitudinal axis of the flow measuring probe runs perpendicularly to the flow direction 118 or to the longitudinal axis of the tube line. An operating circuit 107 is electrically connected to the coil arrangement 106, in particular to the coil 113, and is configured to impress a clocked operating signal to the coil 113 in order to thus produce a clocked magnetic field 109.

The evaluation circuit 119 of the magnetoinductive flow measuring probe 101 is set up to carry out the correction method according to the invention. For this purpose, the evaluation circuit 119 is set up to determine a current magnetic characteristic, in particular a self-inductance or a current variable dependent on the self-inductance. Furthermore, the evaluation circuit 119 is set up to apply a correction factor of a correction function, which is stored or determined as a function of the magnetic characteristic, in particular the self-inductance or the characteristic dependent on the self-inductance and which is determined using the method according to the invention for determining a correction function, to the determined flow-velocity-dependent measurement variable in order to correct it.

FIG. 3 shows a further embodiment of the magnetoinductive flow meter 301 according to the invention. The magnetic-field-generating device 305 of the illustrated embodiment comprises two diametrically arranged saddle coils 306 whose shape adapts in each case to the outer contour of the lateral surface of the measuring tube 302. In addition, the magnetoinductive flow meter 301 can also comprise field guide bodies (not shown) which are set up to guide the magnetic field from one saddle coil 306 to the opposite saddle coil 306. Alternatively, the magnetoinductive flow meter 301 may comprise only exactly one saddle coil 306.

FIG. 4 shows an embodiment of the method according to the invention for correcting the flow-velocity-dependent variable with the method steps 401 to 404.

In a first method step 401, the current magnetic characteristic variable, in particular a self-inductance or a current variable dependent on the self-inductance, of the magnetoinductive flow meter or the magnetoinductive flow measuring probe, is determined. Magnetic-inductive flow meters are already known which are designed to determine, in addition to the flow-velocity-dependent measurement variable, also the self-inductance resulting from the coil current curve, and/or voltage curve over time. The self-inductance results, for example, from the rise behavior in the coil current when rectangular voltage curves are applied. The self-inductance determined in this way is a measure of the presence of magnetic solids in the medium. The self-inductance is a variable that can change and can depend on the temperature and the state of aging of the magnetic-field-generating device.

Subsequently, in a second method step 402, a flow-velocity-dependent measurement variable is determined. The flow-velocity-dependent measurement variable can be an electrical potential measured at a measuring electrode, a potential difference or measurement voltage between two measuring electrodes, a determined flow velocity, a determined volumetric flow or a determined mass flow.

The third method step 403 comprises applying a correction function stored in the magnetoinductive flow meter or in the magnetoinductive flow measuring probe or a correction factor of the correction function to correct the flow-velocity-dependent measurement variable. This is determined at the factory using the method according to the invention and stored in the magnetoinductive flow meter or the magnetoinductive flow measuring probe. The correction function corresponds to the correction function assigned to the determined current magnetic characteristic, in particular the current self-inductance or the variable dependent on the current self-inductance, which assigns the current magnetic characteristic, in particular the current self-inductance or the variable dependent on the current self-inductance, to a correction factor for the flow-velocity-dependent measurement variable.

The correction function is determined in such a way that it is independent of the flow velocity.

The correction function can be a polynomial function with a linear part, where in the linear part, the polynomial function has a slope which corresponds to the factor A.

An optional fourth method step 404 comprises determining an effective magnetic permeability of the medium as a function of the current magnetic characteristic, in particular of the current self-inductance or of a variable dependent on the current self-inductance and/or of the correction factor.

FIG. 5 shows an embodiment of the method according to the invention for determining the correction function for the flow-velocity-dependent measurement variable of a flowable medium for a magnetoinductive flow meter or for a magnetoinductive flow measuring probe, comprising the method steps 501 to 505:

The first method step 501 comprises modeling a magnetic-field-generating device, in particular by means of a preferably numerical simulation method. The modeling of the magnetic-field-generating device takes into account a magnetic permeability of the magnetic-field-generating device or at least of an individual component of the magnetic-field-generating device. The magnetic-field-generating device usually consists of a plurality of individual components such as one or more cylindrical or saddle coils, one or more coil cores, one or more pole shoes and/or one or more field guide bodies. The finite element method is an example of a suitable simulation method.

Depending on the embodiment of the magnetic-field-generating device and the presence of the individual components, the magnetic permeability of the individual component or the magnetic permeabilities of all individual components are taken into account for the modeling; i.e. in the model, the individual component or all individual components are each assigned a magnetic permeability which substantially corresponds to an actual magnetic permeability of the individual component installed in the measuring device. Thus, if at least one coil core is present, the magnetic permeability of the at least one coil core is taken into account in the modeling of the magnetic-field-generating device; i.e., in the model, the magnetic permeability of the coil core actually used in the measuring device is assigned to the coil core. If at least one pole shoe is present, the magnetic permeability of the pole shoe is taken into account in the modeling of the magnetic-field-generating device. If the magnetic-field-generating device has two coils, each with a coil core, which are connected to each other via a field guide body, then in addition to the magnetic permeability of the two coil cores, the magnetic permeability of the field guide body is also taken into account in the modeling of the magnetic-field-generating device.

Once all magnetic permeabilities have been correspondingly assigned to the individual components of the magnetic-field-generating device, the magnetic characteristic of the magnetic-field-generating device resulting from the model, in particular a self-inductance of the magnetic-field-generating device, is determined. The model is sufficiently suitable if the determined magnetic characteristic, in particular the self-inductance, lies within a characteristic tolerance range, in particular self-inductance tolerance range, which is in particular determined experimentally. In addition, a calibration factor C resulting from the modeled magnetic-field-generating device must lie within a calibration factor tolerance range, in particular one that is determined experimentally. The calibration factor C is applied to the measured electrical potential, the measured and/or determined potential difference or measurement voltage to determine the flow velocity or process variables derived therefrom. Furthermore, for a suitable model, the linearity resulting from the modeled magnetic-field-generating device must lie within a linearity tolerance range, in particular one determined experimentally.

If the magnetic characteristic, in particular the self-inductance, is not within the characteristic tolerance range, in particular the self-inductance tolerance range, an adjustment of the modeled magnetic-field-generating device is necessary. This adjustment is preferably carried out by providing a distance between at least two individual components of the magnetic-field-generating device or between a measuring tube of the magnetoinductive flow meter and the magnetic-field-generating device, or between a housing wall of the magnetoinductive flow measuring probe and the magnetic-field-generating device in the model. The volume bounded by the individual components has the magnetic properties of air or a vacuum. The distance is a variable that can change in the model and is varied until the variables to be adjusted match (CALF, self-inductance and/or linearity) the corresponding tolerance range.

The method step 502 comprises determining a first reference state in which the medium to be guided has a first magnetic permeability. Water that is free of magnetic foreign bodies is a suitable medium for this purpose. For the first reference state, a first magnetic characteristic, in particular a first self-inductance or a variable dependent thereon, is determined.

The method step 503 comprises determining a second reference state in which the medium to be guided has a second magnetic permeability deviating from the first permeability. The second magnetic permeability results from the presence of magnetic solids in the medium (e.g. water). During the modeling, the second magnetic permeability is assigned to the overall volume of the water. For the second reference state, a second magnetic characteristic deviating from the first magnetic characteristic, in particular a second self-inductance deviating from the first self-inductance or a variable deviating therefrom, is determined.

The method step 504 includes determining a deviation between the first reference state and the second reference state. In this case, a first deviation between the first magnetic characteristic and the second magnetic characteristic, in particular the first self-inductance and the second self-inductance, is determined. In addition, a second deviation is determined between a first flow-velocity-dependent measurement variable resulting from the first reference state and a second flow-velocity-dependent measurement variable resulting from the second reference state.

The method step 505 includes deriving a correction function from the deviation. The correction function results from a functional relationship between the first deviation or a variable derivable from the first deviation, and the second deviation or a variable derivable from the second deviation. The correction function can be described by means of a polynomial function with at least one linear part and has a linear part with a factor A. The factor A is a magnetic-system-geometry-specific variable and is selected from a first factor range with the limits 1 and 4, in particular 1.5 and 2.5, or their corresponding reciprocal values in the case in which the magnetic-field-generating device comprises a saddle coil, and is selected from a first factor range with the limits 4 and 8, in particular 5 and 7, or their corresponding reciprocal values in the case in which the magnetic-field-generating device comprises a cylindrical coil.

Furthermore, the factor A correlates with a measuring-tube-specific variable or a pipeline-specific variable, in particular with a measuring tube inner diameter in the case of a magnetoinductive flow meter or a pipeline inner diameter in the case of a magnetoinductive flow measuring probe, via a second-order polynomial function.

FIG. 6 shows the functional relationship between the measurement errors caused by magnetic solids in the medium and the change in the determined magnetic characteristic of the magnetic-field-generating device. The plotted measuring points were measured in a test line using a magnetoinductive flow meter. Magnetic foreign bodies with known magnetic properties were mixed in water and pumped through the test line. The error of the flow-velocity-dependent measurement variable (y-axis) was determined using a reference flow meter that is insensitive to magnetic foreign bodies. A Coriolis flow meter was used for this purpose. At the same time, the magnetoinductive flow meter was used to continuously determine the inherent self-inductance. The determined self-inductance is the self-inductance of the magnetic-field-generating device derived from the coil current and/or coil voltage over time. If the measurement error of the flow-velocity-dependent measurement variable is plotted as a function of the change in the determined self-inductance (X-axis), a linear relationship is obtained. This relationship can be well described by the simulated function that is obtained from the model according to the invention. The determined straight line has a slope that corresponds to the factor A according to the invention. If the correction function or factor A is stored in the measuring device and the deviation of the self-inductance from the reference value can be determined, then the error in the flow-velocity-dependent measurement variable caused by magnetic foreign bodies can be determined or corrected.

FIG. 7 shows the functional relationship between the factor A and measuring tube inner diameter or pipeline inner diameter. The factor A (Y-axis) which results from the method according to the invention for determining a correction function, is determined for magnetoinductive flow meters with the same magnetic-field-generating devices but different inner diameters, and is plotted as a function thereof (X-axis).

### LIST OF REFERENCE SIGNS

Magnetic-inductive flow meter 1
Measuring tube 2
Carrier tube 3
Liner 4
Magnetic field-generating device 5
Coil 6
Operating circuit 7
Device for tapping off an induced measurement voltage 8
Controller circuit 10
Coil core 14i
Receptacle of the coil 15
Measurement electrode 17
Measurement electrode 18
Fill-level monitoring electrode 19
Reference electrode 20
Pole shoe 21
Field-conducting body 22
Measuring circuit 23
Evaluation circuit 24
Coil arrangement 25
Magneto-inductive flow measuring probe 101
Housing 102
Measurement electrode 103
Measurement electrode 104
Magnetic-field-generating device 105
Coil arrangement 106
Operating circuit 107
Field-conducting arrangement 108
Magnetic field 109
Field-conducting body 110
Coil core 111
Pole shoe 112
Coil 113
Field return body 114
Front body 115
End section 116
Housing wall 117
Direction of flow of the medium 118
Evaluation circuit 119

1-22. (canceled)

23. A method for determining a correction function of a flow-velocity-dependent measurement variable of a flowable medium for a magnetoinductive flow meter or for a magnetoinductive flow measuring probe, the method comprising:
modeling a magnetic-field-generating device via a numerical simulation method, wherein the modeling of the magnetic-field-generating device is influenced by a magnetic permeability of the magnetic-field-generating device or at least of an individual component of the magnetic-field-generating device;
determining a first reference state in which the medium to be guided has a first magnetic permeability;
determining a second reference state in which the medium to be guided has a second magnetic permeability different from the first magnetic permeability;
determining a deviation between the first reference state and the second reference state; and
deriving the correction function from the deviation.

24. The method according to claim 23,
wherein the modeling of the magnetic-field-generating device includes adapting the model so that a magnetic characteristic of the magnetic-field-generating device resulting from the modeled magnetic-field-generating device lies within a characteristic tolerance range.

25. The method according to claim 24,
wherein the modeling of the magnetic-field-generating device includes adapting the model so that a calibration factor resulting from the modeled magnetic-field-generating device C lies within a calibration factor tolerance range.

26. The method according to claim 23,
wherein the modeling of the magnetic-field-generating device includes an adaptation thereof so that a linearity resulting from the modeled magnetic-field-generating device lies within a linearity tolerance range.

27. The method according to claim 26,
wherein when modeling the magnetic-field-generating device, a distance is assumed between at least two individual components of the magnetic-field-generating device, or between a measuring tube of the magnetoinductive flow meter and the magnetic-field-generating device, or between a housing wall of the magnetoinductive flow measuring probe and the magnetic-field-generating device, and
wherein the modeling includes adjusting the distance until the variables to be adjusted match the corresponding tolerance range.

28. The method according to claim 23,
wherein the magnetic-field-generating device comprises a coil and a coil core,
wherein a magnetic permeability of the coil core is included in the modeling of the magnetic-field-generating device.

29. The method according to claim 28
wherein the magnetic-field-generating device includes a pole shoe,
wherein a magnetic permeability of the pole shoe is included in the modeling of the magnetic-field-generating device.

30. The method according to claim 23,
wherein the magnetic-field-generating device includes two coils, each with a coil core and a field guide body connecting the two coil core,
wherein the magnetic permeability of the two coil cores and of the field guide body is included in the modeling of the magnetic-field-generating device.

31. The method according to claim 23,
wherein the magnetic-field-generating device includes a coil and a field guide body,
wherein a magnetic permeability of the field guide body is included in the modeling of the magnetic-field-generating device.

32. The method according to claim 23, further comprising:
in the first reference state, determining a first magnetic characteristic
in the second reference state, determining a second magnetic characteristic differing from the first magnetic characteristic.

33. The method according to claim 32,
wherein determining the deviation between the first reference state and the second reference state includes determining a first deviation between the first magnetic characteristic and the second magnetic characteristic.

34. The method according to claim 33,
wherein determining the deviation between the first reference state and the second reference state includes determining a second deviation between a first flow-velocity-dependent measurement variable resulting from the first reference state and a second flow-velocity-dependent measurement variable resulting from the second reference state.

35. The method according to claim 34,
wherein the correction function results from a functional relationship between the first deviation, or a variable derivable from the first deviation, and the second deviation, or a variable derivable from the second deviation.

36. The method according to claim 35,
wherein the correction function can be described by a polynomial function with at least one linear part, wherein the linear part includes a factor A.

37. The method according to claim 36,
wherein the factor A is a magnetic-system-geometry-specific variable.

38. The method according to claim 37,
wherein the factor A is selected from a first factor range with the limits 1 and 4 or their corresponding reciprocals when the magnetic-field-generating device includes a saddle coil, and
wherein the factor A is selected from a first factor range with the limits 4 and 8 or their corresponding reciprocals when the magnetic-field-generating device includes a cylindrical coil.

39. The method according to claim 38,
wherein the factor A correlates with a measuring-tube-specific variable or a pipeline-specific variable via a second-order polynomial function.

40. A method for correcting a flow-velocity-dependent measurement variable of a magnetoinductive flow meter or a magnetoinductive flow meter probe, comprising:
determining a current magnetic characteristic of the magnetoinductive flow meter or the magnetoinductive flow measuring probe;
determining the flow-velocity-dependent measurement variable;
determining a correction function of the flow-velocity-dependent measurement variable, wherein the determining includes:
modeling a magnetic-field-generating device via a numerical simulation method, wherein the modeling of the magnetic-field-generating device is influenced by a magnetic permeability of the magnetic-field-generating device or at least of an individual component of the magnetic-field-generating device;
determining a first reference state in which a medium to be guided has a first magnetic permeability;
determining a second reference state in which the medium to be guided has a second magnetic permeability different from the first magnetic permeability;
determining a deviation between the first reference state and the second reference state; and
deriving the correction function from the deviation; and
applying a correction factor of the correction function for the determined current magnetic characteristic for the correction of the flow-velocity-dependent measurement variable,
wherein the correction function assigns the current magnetic characteristic to the correction factor for the flow-velocity-dependent measurement variable.

41. The method according to claim 40,
wherein the correction function is independent of the flow velocity.

42. The method according to claim 41, further comprising:
determining an effective magnetic permeability of the medium as a function of the current magnetic characteristic and/or of the correction factor.

43. A magnetoinductive flow meter for detecting a flow-velocity-dependent measurement variable of a flowable medium, comprising:
a measuring tube for conducting the medium;
a magnetic-field-generating device for generating a magnetic field that penetrates the measuring tube;
at least one measuring electrode for determining a measurement voltage induced in the flowable medium; and
an evaluation circuit for determining the flow-velocity-dependent measurement variable,
wherein the evaluation circuit is configured to correct the flow-velocity-dependent measurement variable of the magnetoinductive flow meter by:
determining a current magnetic characteristic of the magnetoinductive flow meter;
determining the flow-velocity-dependent measurement variable;
determining a correction function of the flow-velocity-dependent measurement variable, wherein the determining includes:
modeling a magnetic-field-generating device via a numerical simulation method, wherein the modeling of the magnetic-field-generating device is influenced by a magnetic permeability of the magnetic-field-generating device or at least of an individual component of the magnetic-field-generating device;
determining a first reference state in which the medium has a first magnetic permeability;
determining a second reference state in which the medium has a second magnetic permeability different from the first magnetic permeability;
determining a deviation between the first reference state and the second reference state; and
deriving the correction function from the deviation; and
applying a correction factor of the correction function for the determined current magnetic characteristic for the correction of the flow-velocity-dependent measurement variable,
wherein the correction function assigns the current magnetic characteristic to the correction factor for the flow-velocity-dependent measurement variable.

44. A magnetoinductive flow measuring probe for detecting a flow-velocity-dependent measurement variable of a flowable medium, wherein the magnetoinductive flow measuring probe can be arranged in an opening of a pipeline, the magnetoinductive flow measuring probe comprising:
a housing embodied to contact the medium;
a magnetic-field-generating device for generating a magnetic field that penetrates the housing, wherein the magnetic-field-generating device is arranged in the housing;
at least one measuring electrode for determining a measurement voltage induced in the medium; and
an evaluation circuit for determining the flow-velocity-dependent measurement variable,
wherein the evaluation circuit is configured to correct the flow-velocity-dependent measurement variable of the magnetoinductive flow meter by:
determining a current magnetic characteristic of the magnetoinductive flow meter;
determining the flow-velocity-dependent measurement variable;
determining a correction function of the flow-velocity-dependent measurement variable, wherein the determining includes:
modeling a magnetic-field-generating device via a numerical simulation method, wherein the modeling of the magnetic-field-generating device is influenced by a magnetic permeability of the magnetic-field-generating device or at least of an individual component of the magnetic-field-generating device;
determining a first reference state in which the medium has a first magnetic permeability;
determining a second reference state in which the medium has a second magnetic permeability different from the first magnetic permeability;
determining a deviation between the first reference state and the second reference state; and
deriving the correction function from the deviation; and
applying a correction factor of the correction function for the determined current magnetic characteristic for the correction of the flow-velocity-dependent measurement variable,
wherein the correction function assigns the current magnetic characteristic to the correction factor for the flow-velocity-dependent measurement variable.
